(19) United States
(12) Patent Application Publication
(10) Pub. No.: US 2008/0214429 A1
(43) Pub. Date: Sep. 4, 2008

(54) Film-form compositions for delivery of soaps

(75) Inventor: Reg Macquarrie, Toronto (CA)

Correspondence Address: DINESH AGARWAL, P.C., 5350 SHAWNEE ROAD, SUITE 330, ALEXANDRIA, VA, 22312, US

(73) Assignee: LIVING CELL RESEARCH INC., TORONTO (CA)

(21) Appl. No.: 12/010,515

(22) Filed: Jan. 25, 2008

Related U.S. Application Data
(60) Provisional application No. 60/886,703, filed on Jan. 26, 2007.

(51) Int. Cl. C11D 17/06

(52) U.S. Cl. 510/445

(57) ABSTRACT

Film-form soap compositions for hand washing or other personal hygienic uses are described in which hydroxypropyl methyl cellulose polymer is admixed with sodium isothionate surfactant to provide compositions having superior properties of strength, rapid dissolution in water and good foaming properties.

### BACKGROUND OF THE INVENTION

This invention relates to rapid dissolving film formulations for the quick and convenient delivery of surfactants upon the addition of water, e.g. a soap for personal washing applications.

Although a number of carbohydrate based hydrocolloids have been proposed as the polymer basis for film-form compositions for delivery of soaps, detergents, etc., I have found that hydroxypropyl methycellulose (HPMC) is an unusually good choice owing to its strength, rapid dissolution in water and natural foaming properties. Unlike materials such as carboxymethyl cellulose, HPMC is compatible with cold mixing and the production of soap films which will not stick together.

### SUMMARY OF THE INVENTION

I have found that the water soluble polymer hydroxypropyl methyl cellulose (HPMC) in combination with sodium isothionate as the primary surfactant provides a basis for films of superior properties that function as soap for personal hygiene applications. Compositions according to the present invention are in the form of a thin film which dissolves on contact with water and are, as such, very convenient to use.

### DETAILED DESCRIPTION OF THE INVENTION

Personal wash films according to the present invention comprise the following essential components:
(i) up to 25 percent by weight of a carrier polymer including a major portion of low molecular weight HPMC polymer
(ii) at least 35 percent by weight of sodium isothionate (primary surfactant)
(iii) one or more secondary co-surfactants such as cocamidopropyl betaine
(iv) a plasticizer, preferably polypropylene glycol Any of a number of fragrance or color additives may be included, as desired.

Low molecular weight HPMC (12-18 cps, in 2% aqueous solution at 20° C.) is preferred, as it dissolves more rapidly and rinses cleanly, with little or no “slimy” sensation. Methocel A15™ (Dow Chemical Corporation), and Metolose™ MCE-15 (Shin-Etsu Chemical Co. Ltd.), are examples of suitable HPMC polymers.

Propylene glycol is preferred as a plasticizer, as it has natural surfactant properties and does not suppress foam production, as is the case with other humectants such as glycerol.

Sodium isothionate is unusually suitable as the primary surfactant in personal wash films, owing to its mildness (derived from natural sources), compatibility with HPMC and most important—it's tendency to produce a very dense, stable foam.

A lesser amount of one or more co-surfactants is required to improve performance by accelerating lather production and providing a more “open” foam.

### Preparation of Personal Wash Films According to the Invention

1. Cold mixing is carried out in three stages:
a. polymer hydration (water+polymer+plasticizer)
b. surfactant dissolution & blending (polymer blend+other)
c. aeration of slurry (specific gravity less than 0.9 g/ml)

2. Casting of slurry mix to form a film

3. Die-cutting & embossing (or optionally, printing) of the soap film

HPMC must be mixed in cold water (less than 30° C.), and separately from surfactants in order for thorough hydration of the polymer to occur. The polymer should be mixed under rapid agitation, until smooth and for a minimum of about 30 minutes before addition of surfactants and fragrance.

Once polymer hydration is complete, surfactants can be blended into the mix. This results in a slurry which is very stable, and can be held for several weeks under ambient (5-30° C.) storage conditions, until needed.

Aeration, as a third and final stage of mixing, may be carried out to reduce the specific gravity from an initial level of about 0.9 g/ml. A specific gravity of less than 0.86 vastly improves dissolution rate, and most important—produces a dry cast film which is bright white (no color is added), opaque, and can be easily embossed (see below).

The specific combination of HPMC and sodium isothionate, results in a film with performance characteristics which are exceptionally well suited to personal wash applications, but with adequate strength to allow for unsupported casting (eg. cast directly onto stainless steel belt or other suitable drying surface, without need for a carrier backing film).

If a carrier film is required (eg. for production of film in roll stock form), bare aluminum foil and/or poly-coated aluminum foil is used. Film tends to stick to conventional polyethylene-based carriers, and Mylar™).

Film can be sheeted and stored for die cutting and embossing at a later stage, or die cut immediately off the production line.

Embossing of the film is achieved by compression of the aerated film with a rubber stamp, or means similar to that used in flexographic printing processes. Initial film thickness is approximately 150 microns. Upon embossing, the affected area compresses to a thickness of about 80 microns, giving a relief to the surrounding film and allowing the improved image (e.g. trademark) to be clearly visible.

Alternatively, films may be printed on by one of several means, including ink jet, or flexographic printing.

Embossing of film strips may be conveniently achieved during the die cutting stage, which allows for improved production efficiency and correct registration of the logo (embossed image) on the finished strip.

| | WEIGHT PERCENT |
|---|---|
| INGREDIENT | [DRY FILM BASIS] |
| EXAMPLE 1 | |
| WATER | 10.7 |
| HYDROXYLPROPYL | 19.6 |
| METHYLCELLULOSE MCE-15 | |
| PROPYLENE GLYCOL | 5.9 |
| SURFACTANT-SODIUM ISOTHIONATE | 44.5 |
| CO-SUFACTANT | 14.8 |
| FRAGRANCE | 4.5 |
| COLOR-FD&C-BLUE #1/YELLOW #5 | 0.001 |
| FILM 240 TO 260 MICRONS THICK | 100 |
| EXAMPLE 2 | |
| WATER | 10.71 |
| HYDROXYLPROPYL | 15.9 |
| METHYLCELLULOSE A15 | |
| PROPYLENE GLYCOL | 4.8 |
| GLYCERIN | 3.2 |
| SURFACTANT-SODIUM ISOTHIONATE | 39.8 |
| CO-SURFACTANT-GENAGAN CAB | 24 |
| FRAGRANCE | 1.5 |
| FILM 200 TO 220 MICRONS THICK. | 100 |

I claim:

1. A rapidly soluble film-form composition for the delivery of a surfactant upon the addition of water, comprising:
(i) a water soluble base carrier consisting primarily of hydroxypropyl methyl cellulose, making up less than 25% of the weight of the film;
(ii) at least one surfactant including sodium isothionate, in an amount such that isothionate content on a finished film basis is not less than 35% of the film by weight;
(iii) between 7% and 15% by weight of water based on the weight of the film; and
(iv) at least one plasticizer in a total amount 10% or less of the finished film weight.

2. A method for preparing a rapidly water soluble film-form composition for the delivery of a surfactant, comprising the steps of:
(i) mixing hydroxypropyl methyl cellulose with cold water at a temperature of less than 30° C. to effect thorough hydration of the polymer;
(ii) blending in at least one surfactant including sodium isothionate to produce a slurry; and
(iii) adding water and plasticizer and mixing with aeration to produce a mixture having a specific gravity of less than 0.9 g/ml; and
(iv) casting film from the mixture.

3. A method according to claim 2, further comprising aeration of said slurry by the controlled introduction of gas during casting.

4. A method according to claim 1, further comprising die-cutting the cast film into single-use portions and embossing or printing a selected design on each portion.
